(19) United States
(12) Patent Application Publication
(10) Pub. No.: US 2021/0246932 A1
(43) Pub. Date: Aug. 12, 2021

(54) INTERNALLY THREADED FASTENER HAVING A PREVAILING TORQUE FEATURE

(71) Applicant: Production Spring, LLC, Troy, MI (US)

(72) Inventors: Lawrence Johnson, Taylor, MI (US); Arturo Spaccarotelli, Saint Clair Shores, MI (US); Alfred Rosbury, Detroit, MI (US)

(73) Assignee: Production Spring, LLC, Troy, MI (US)

(21) Appl. No.: 16/786,537

(22) Filed: Feb. 10, 2020

(51) Int. Cl. F16B 39/30; F16B 37/04; B21C 23/14; B21D 53/24

(52) U.S. Cl. CPC F16B 39/30; B21D 53/24; B21C 23/14; F16B 37/041

(57) ABSTRACT

A threaded fastener having a prevailing torque feature and a method for forming same includes a barrel having a longitudinal axis. The barrel has a plurality of internal threads, each internal thread including a forward facing surface and a rearward facing surface. A first angle between the forward facing surface and a first lateral axis perpendicular to the longitudinal axis ranges from 20° to 40°. A second angle between the forward facing surface and the rearward facing surface ranges from 80° to 100°.

### TECHNICAL FIELD

The present specification generally relates to threaded fasteners that do not vibrate loose during use over time and, more specifically, internally threaded fasteners for securing an externally threaded fastener during use.

### BACKGROUND

Over time, an externally threaded fastener will tend to loosen from its associated internally threaded fastener due to vibrations. Thus, internally threaded fasteners may be formed to include a ramped profile, referred to as a prevailing torque feature, for preventing the externally threaded fastener from disengaging the internally threaded fastener over time. The prevailing torque features may include crimping of an end of the internally threaded fastener. However, this limits the size of the externally threaded fastener as a longer externally threaded fastener is required when the end is crimped in order to ensure that the threads of the fasteners engage.

Alternatively, prevailing torque features are contemplated for providing a ramped profile on the internal threads of the fastener itself. However, formation of these internal threads having a ramped profile is not found in an extruded fastener, such as an extruded nut, due to the complex and expensive nature in forming the ramped profile in these internally threaded fasteners.

Accordingly, a need exists for alternative internally threaded fasteners for securing an externally fastener during use.

### SUMMARY

In one embodiment, a threaded fastener having a prevailing torque feature includes a barrel having a longitudinal axis. The barrel has a plurality of internal threads, each internal thread including a forward facing surface and a rearward facing surface. A first angle between the forward facing surface and a first lateral axis perpendicular to the longitudinal axis ranges from 20° to 40°. A second angle between the forward facing surface and the rearward facing surface ranges from 80° to 100°.

In another embodiment, a method for forming an internally threaded fastener having a prevailing torque feature includes providing a piece of sheet material, extruding the piece of sheet material to form a barrel having a longitudinal axis, and deforming the barrel to form a plurality of internal threads within the barrel, each internal thread including a forward facing surface and a rearward facing surface. A first angle between the forward facing surface and a first lateral axis perpendicular to the longitudinal axis ranges from 20° to 40°. A second angle between the forward facing surface and the rearward facing surface ranges from 80° to 100°.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of an embodiment of an internally threaded fastener, according to one or more embodiments shown and described herein;

FIG. 2 schematically depicts a cross-sectional view of the internally threaded fastener and an externally threaded fastener extending therethrough, according to one or more embodiments shown and described herein;

FIG. 3 schematically depicts an enlarged cross-sectional view taken along circle 3 of FIG. 2 showing the internally threaded fastener and the externally threaded fastener extending therethrough in a loosened state, according to one or more embodiments shown and described herein;

FIG. 4 schematically depicts a cross-sectional view of the internally threaded fastener of FIG. 2 and the externally threaded fastener extending therethrough in a tightened state, according to one or more embodiments shown and described herein;

FIG. 5 schematically depicts an enlarged cross-section view of another embodiment of the internally threaded fastener and the externally threaded fastener extending therethrough in a loosened state, according to one or more embodiments shown and described herein;

FIG. 6 schematically depicts a cross-sectional view of the internally threaded fastener of FIG. 5 and the externally threaded fastener extending therethrough in a tightened state, according to one or more embodiments shown and described herein; and

FIG. 7 schematically depicts a progression of a sheet metal blank being formed into the internally threaded fastener through a deep drawing process.

### DETAILED DESCRIPTION

Embodiments described herein are directed to an internally threaded fastener that includes a prevailing torque feature for preventing loosening of an externally threaded fastener during use. Various embodiments of the internally threaded fastener are described in more detail herein. Whenever possible, the same reference numerals will be used throughout the drawings to refer to the same or like parts.

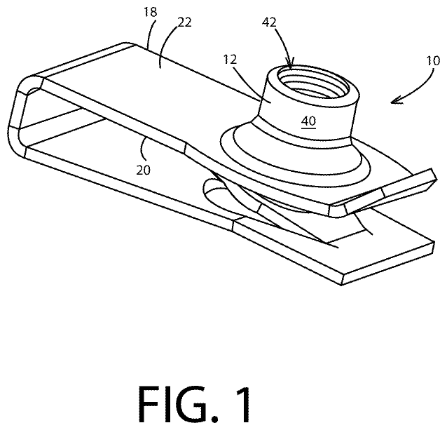

Referring now to FIG. 1, an internally threaded fastener 10 is illustrated according to one or more embodiments described herein. It should be appreciated that the internally threaded fastener 10 is any suitable internally threaded fastener. As such, the internally threaded fastener 10 may be an extruded nut such as, for example, a u-nut, a t-nut, a box nut, or the like. As shown, the internally threaded fastener is a u-nut.

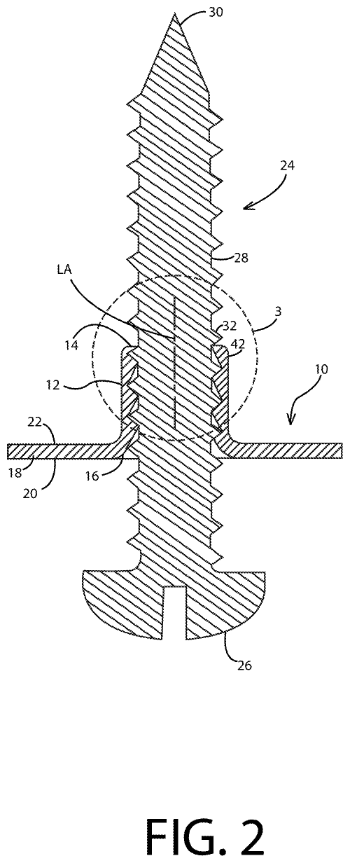

Referring to FIGS. 2-4, the internally threaded fastener 10 includes a barrel 12 having first end 14 and a second end 16. The internally threaded fastener 10 has a longitudinal axis LA extending through the barrel 12. The internally threaded fastener 10 includes a base plate 18 having a first surface 20 and an opposite second surface 22. The base plate 18 extends substantially orthogonal to the longitudinal axis LA. In some embodiments, the barrel 12 and the base plate 18 are generally perpendicular to one another and integrally formed. As such, the barrel 12 and the base plate 18 are molded and/or extruded as an integrally formed one piece monolithic structure.

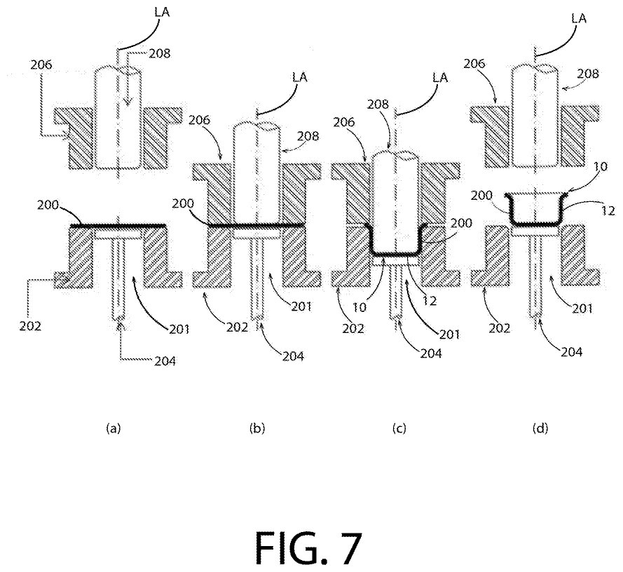

More particularly, as shown in FIG. 7, a plurality of stages (a)-(d) are illustrated in which the internally threaded fastener 10 is formed through a deep drawing process. In a first stage (a) of the deep drawing process a sheet metal blank 200 is provided across an end of a hollow cavity 201 formed in a die 202. A knockout 204 is inserted within the hollow cavity 201 in order to support the sheet metal blank 200. A blank holder 206 is positioned facing a surface of the metal blank 200 opposite the knockout 204 and spaced apart therefrom. In a second stage (b), the blank holder 206 and the punch 208 are lowered along a longitudinal axis LA toward the die 202 and brought into contact with the sheet metal blank 200. In a third stage (c), the punch 208 is further lowered with respect to the blank holder 206 and extends into the hollow cavity 201 of the die 202. As the punch 208 extends into the hollow cavity 201 of the die 202, the knockout 204 is also moved along the longitudinal axis LA with respect to the die 202 in order to permit the sheet metal blank 202 to be extruded and formed into the barrel 12 of the internally threaded fastener 10. The barrel 12 may be formed by incrementally and repeatedly extruding the sheet metal blank 200 until the sheet metal blank ruptures, is cut, or is tapped, to form a head at the first end 14 of the internally threaded fastener 10. Tapping the barrel 12 then forms internal threads within the barrel 12, as discussed in more detail herein. The unextruded portion of the sheet material is then cut to form the base plate 18. The internally threaded fastener 10 may be formed by extruding the barrel 12 any suitable number of times. For example, the internally threaded fastener 10 may be formed by extruding the barrel 12 two, four, six, eight, or ten times based on the thickness of the sheet metal blank 200 and the desired dimensions of the barrel 12. The internally threaded fastener 10 may be formed of any suitable piece of sheet material such as metal, steel, or the like. In some embodiments, the internally threaded fastener 10 is formed from a metallic material. More particularly, the metallic material is spring steel.

As illustrated in FIGS. 2-4, an externally threaded fastener 24 is shown engaging the internally threaded fastener 10 and inserted through the second end 16 of the barrel 12. The externally threaded fastener 24 may be any suitable fastener such as, for example, a screw or a bolt. The externally threaded fastener 24 has a head 26, a shaft 28, and a tip 30. The longitudinal axis LA extending through the barrel 12 is parallel to the shaft 28 of the externally threaded fastener 24 when inserted therethrough. A plurality of external threads 32 encircle the shaft 28 and extend outwardly therefrom. Each external thread 32 includes a rearward facing surface 34 and a forward facing surface 36.

Throughout the ensuing description, reference to a “rearward facing surface” and a “forward facing surface” is understood as referring to an insertion direction of the externally threaded fastener 24 with respect to the internally threaded fastener 10. Thus, the rearward facing surface 34 of the external threads 32 of the externally threaded fastener 24 faces the head 26 of the externally threaded fastener 24 and the forward facing surface 36 of the external threads 32 of the externally threaded fastener 24 faces the tip 30 of the externally threaded fastener 24.

When the externally threaded fastener 24 is fully screwed into the internally threaded fastener 10 and in an engaged state, as discussed in more detail below, the head 26 of the externally threaded fastener 24 may abut against the first surface 20 of the base plate 18.

The barrel 12 of the internally threaded fastener 10 has an interior surface 38 and an exterior surface 40. The barrel 12 of the internally threaded fastener 10 includes a plurality of internal threads 42 extending between the first end 14 and the second end 16 of the barrel 12 and formed within the interior surface 38 of the barrel 12 of the internally threaded fastener 10. Each internal thread 42 has a forward facing surface 44 and a rearward facing surface 46. The external threads 32 of the externally threaded fastener 24 engage the internal threads 42 of the barrel 12 of the internally threaded fastener 10 when screwed thereon. The internal threads 42 are formed by deforming the interior surface 38 of the barrel 12 in any suitable manner such as by tapping, cutting, or rolling.

Reference to the forward facing surface 44 of the internal threads 42 of the internally threaded fastener 10 is to be understood as facing the tip 30 of the externally threaded fastener 24 and the rearward facing surface 46 of the internal threads 42 of the internally threaded fastener 10 is to be understood as facing the head 26 of the externally threaded fastener 24.

More particularly, the forward facing surface 44 of the internal threads 42 has a first end 48 and a second end 50. Similarly, the rearward facing surface 46 of the internal threads 42 has a first end 52 and a second end 54. The first end 48 of the forward facing surface 44 extends from the first end 52 of the rearward facing surface 46.

The internal threads 42 of the internally threaded fastener 10 includes a prevailing torque feature 56 in order to prevent unscrewing of the externally threaded fastener 24 from the internally threaded fastener 10 over time caused by external forces, such as vibration. As such, the prevailing torque feature 56 discussed herein is formed by an angular separation between the forward facing surface 44 and the rearward facing surface 46 of the internally threaded fastener 10, as well as an angular separation between the forward facing surface 44 and a first lateral axis L1. The first lateral axis L1 is a straight imaginary line that extends through the second end 50 of the forward facing surface 44 of the internal threads 42 and is perpendicular to the longitudinal axis LA.

The prevailing torque feature 56 is formed by a first angle A1 between the forward facing surface 44 and the first lateral axis L1. In some embodiments, the first angle A1 ranges from 20° to 40°. More particularly, in some embodiments, the first angle A1 ranges from 25° to 35°.

In addition, as noted above, the prevailing torque feature 56 may be formed by the combination of the first angle A1 and a second angle A2 between the forward facing surface 44 and the rearward facing surface 46 of the internal threads 42. In some embodiments, the second angle A2 ranges from 80° to 100°. More particularly, in some embodiments, the second angle A2 ranges from 85° to 95°.

The barrel 12 of the internally threaded fastener 10 includes a planar wall 58 defined by the interior surface 38 thereof and has a first end 60 and a second end 62. The planar wall 58 extends parallel to the longitudinal axis LA and the shaft 28 of the externally threaded fastener 24 when inserted therein. More particularly, the planar wall 58 extends between adjacent internal threads 42 such that the first end 60 of the planar wall 58 extends from the second end 50 of the rearward facing surface 46 of the internal threads 42 and the second end 62 of the planar wall 58 extends from the second end 50 of the forward facing surface 44 of the internal threads 42.

The internally threaded fastener 10 and the externally threaded fastener 24 are positionable between an engaged state and a disengaged state. In the engaged state, the each of the internal threads 42 of the internally threaded fastener 10 are engaged by the external threads 42 of the externally threaded fastener 24. In the disengaged state, at least one of the internal threads 42 of the internally threaded fastener 10 is not engaged by the external threads 42 of the externally threaded fastener 24. It is understood that in the disengaged state, the externally threaded fastener 24 is either separate from the internally threaded fastener 10 or not fully engaged therewith.

When in the engaged state, the internally threaded fastener 10 and the externally threaded fastener 24 are also positionable between a loosened state and a tightened state. As a clamp load is applied onto the externally threaded fastener 24 by compressing a plate (not shown) between the head 26 of the externally threaded fastener 24 and the first surface 20 of the base plate 18, the externally threaded fastener 24 is shifted axially along the longitudinal axis LA with respect to the internally threaded fastener 10.

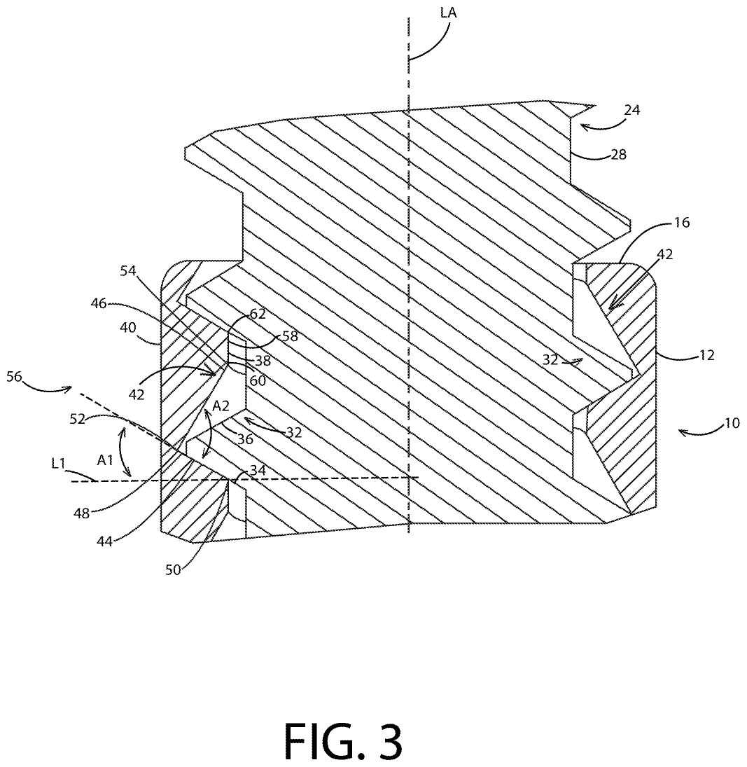

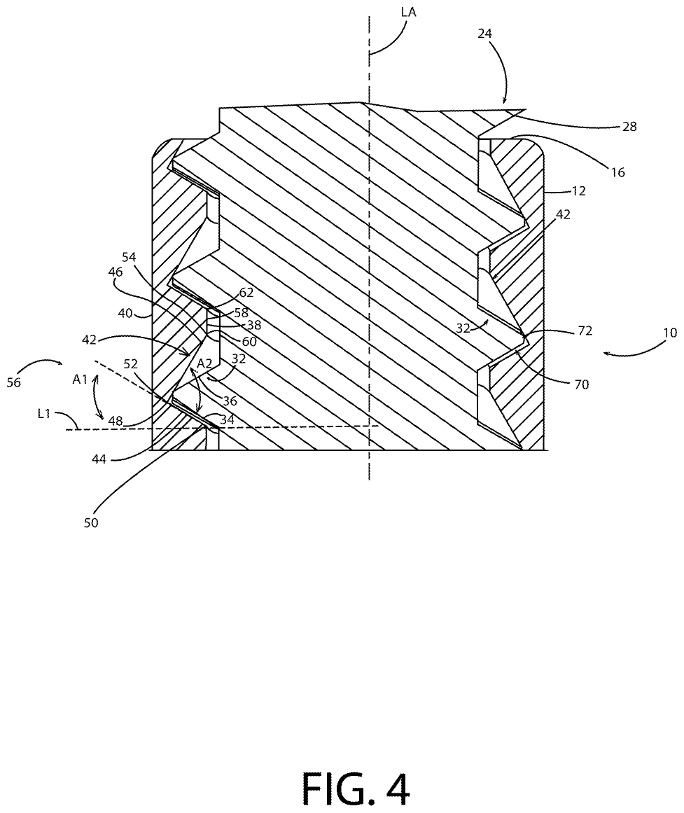

In the engaged and loosened state, as shown in FIG. 3, the rearward facing surface 34 of the external threads 32 abuts against the forward facing surface 44 of the internal threads 42. To the contrary, in the engaged and tightened state, as shown in FIG. 4, a gap 70 is provided between the rearward facing surface 34 of the external threads 32 and the forward facing surface 44 of the internal threads 42. As shown in FIG. 4, a crest 72 of the external threads 32 of the externally threaded fastener 24 contacts the rearward facing surface 46 of the internal threads 42. The prevailing torque feature 56 formed by the forward facing surface 44 and the rearward facing surface 46 of the internal threads 42, which is oriented at the first angle A1 and the second angle A2, respectively, prevent the externally threaded fastener 24 from loosening from the internally threaded fastener 10 over time.

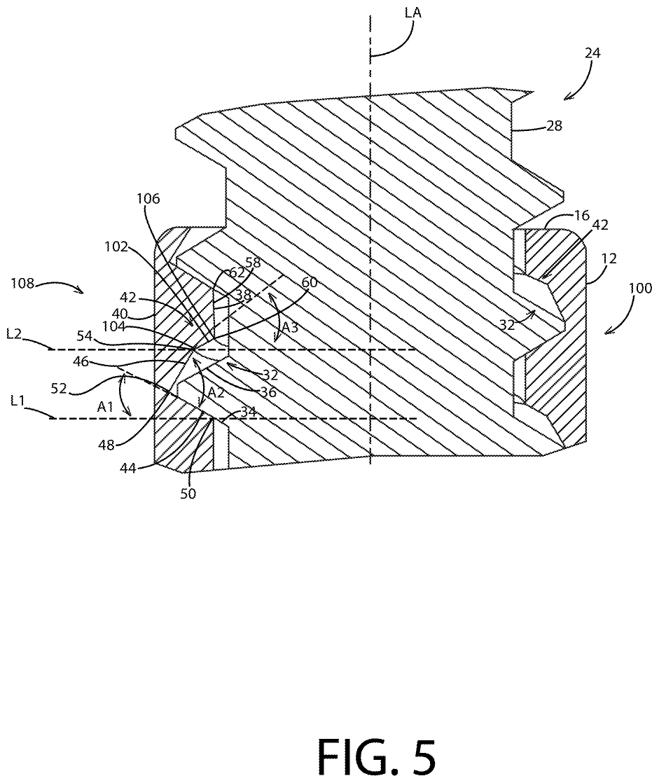

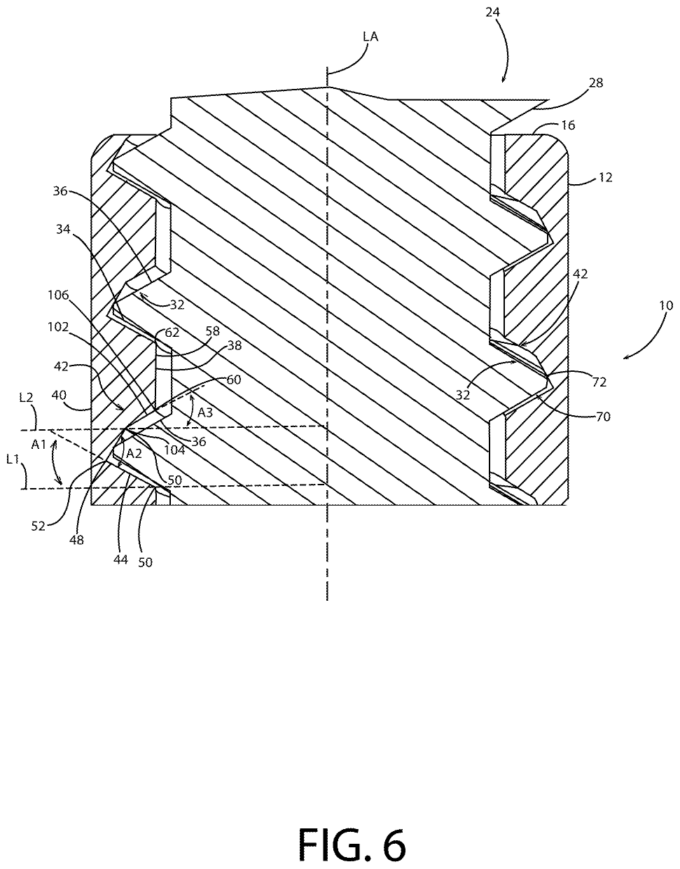

Referring now to FIGS. 5 and 6, another embodiment of an internally threaded fastener 100 is illustrated with the externally threaded fastener 24 extending therethrough. It should be appreciated that the internally threaded fastener 100 discussed above is substantially similar than the internally threaded fastener 10. Thus, like parts will be referred to with like reference numerals.

Each internal threads 42 of the internally threaded fastener 100 includes a diverging surface 102. The diverging surface 102 has a first end 104 and a second end 106. The first end 104 of the diverging surface 102 extends from the second end 54 of the rearward facing surface 46 of the internal threads 42 and the second end 106 of the diverging surface 102 extends from the first end 60 of the planar wall 58.

A second lateral axis L2 is a straight imaginary line that extends through an intersection of the second end 54 of the rearward facing surface 46 and the first end 104 of the diverging surface 102. The second lateral axis L2 is parallel to the first lateral axis L1 and, thus, perpendicular to the longitudinal axis LA of the internally threaded fastener 100. In this embodiment, a prevailing torque feature 108 is further formed by a combination of the first angle A1, the second angle A2, and a third angle A3 between the first end 104 of the diverging surface 102 and the second lateral axis L2. In some embodiments, the third angle A3 ranges from 10° to 30°. More particularly, in some embodiments, the third angle A3 ranges from 15° to 25°.

It should be appreciated that the formation of the diverging surface 102 reduces a length of the rearward facing surface 46 of the internal threads 42. Thus, a length of the planar wall 58 on the interior surface 38 of the internally threaded fastener 100 is increased.

In the engaged and loosened state, as shown in FIG. 5, the rearward facing surface 34 of the external threads 32 abuts against the forward facing surface 44 of the internal threads 42. To the contrary, in the engaged and tightened state, as shown in FIG. 6, the gap 70 is provided between the rearward facing surface 34 of the external threads 32 and the forward facing surface 44 of the internal threads 42. As shown in FIG. 6, the crest 72 of the external threads 32 of the externally threaded fastener 24 contacts the rearward facing surface 46 of the internal threads 42. In this embodiment, the diverging surface 102 provides proof load for additional support and to increase tensile strength. The prevailing torque feature 108 in the internally threaded fastener 100 formed by the forward facing surface 44, the rearward facing surface 46, and the diverging surface 102 of the internal threads 42, which is oriented at the first angle A1, the second angle A2, and the third angle A3, respectively, prevent the externally threaded fastener 24 from loosening from the internally threaded fastener 100 over time.

In both the prevailing torque feature 56, 108, it should be appreciated that the externally threaded fastener 24 spins freely relative to the internally threaded fastener 10 while in the loosened state. Once the head 26 of the externally threaded fastener 24 compresses a plate (not shown) against the first surface 20 of the base plate 18 and the externally threaded fastener 24 is positioned in the tightened state with respect to the internally threaded fastener 10, the crest 72 (FIGS. 4 and 6) of the external threads 32 of the externally threaded fastener 24 is drawn tightly against the rearward facing surface 46 of the internal threads 42 of the internally threaded fastener 10. This creates a continuous helical interference line of edge-to-surface contact along the entire length of the internally threaded fastener 10. As the clamp load increases and the externally threaded fastener 24 moves into the tightened state, the rearward facing surface 46 of the internal threads 42 pushes against the forward facing surface 36 of the external threads 32 from all sides, thereby eliminating any radial or helical clearance that allows typical fasteners to self-loosen under vibration or other external forces.

From the above, it is to be appreciated that defined herein is an internally threaded fastener having a prevailing torque feature for preventing loosing of an externally threaded fastener inserted therein during use.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An internally threaded fastener having a prevailing torque feature, comprising:
a barrel having a longitudinal axis, the barrel having a plurality of internal threads, each internal thread including a forward facing surface and a rearward facing surface,
wherein a first angle between the forward facing surface and a first lateral axis perpendicular to the longitudinal axis ranges from 20° to 40°,
wherein a second angle between the forward facing surface and the rearward facing surface ranges from 80° to 100°.

2. The internally threaded fastener of claim 1, wherein the first angle ranges from 25° to 35°.

3. The internally threaded fastener of claim 2, wherein the second angle ranges from 85° to 95°.

4. The internally threaded fastener of claim 1, further comprising a base plate, the barrel extending perpendicular to the base plate.

5. The internally threaded fastener of claim 4, wherein the barrel and the base plate are integrally formed as a one piece monolithic structure.

6. The internally threaded fastener of claim 1, wherein the internally threaded fastener is one of a u-nut, a t-nut, or a box nut.

7. The internally threaded fastener of claim 1, further comprising a planar wall extending parallel to the longitudinal axis and between adjacent internal threads of the plurality of internal threads.

8. The internally threaded fastener of claim 1, wherein the rearward facing surface includes a first end and a second end, a diverging surface extending from the second end of the rearward facing surface, wherein a third angle between the diverging surface and a second lateral axis perpendicular to the longitudinal axis ranges from 10° to 30°.

9. The internally threaded fastener of claim 8, wherein the third angle ranges from 15° to 25°.

10. A method for forming an internally threaded fastener having a prevailing torque feature, comprising:
providing a piece of sheet material;
extruding the piece of sheet material to form a barrel having a longitudinal axis; and
deforming the barrel to form a plurality of internal threads within the barrel, each internal thread including a forward facing surface and a rearward facing surface,
wherein a first angle between the forward facing surface and a first lateral axis perpendicular to the longitudinal axis ranges from 20° to 40°,
wherein a second angle between the forward facing surface and the rearward facing surface ranges from 80° to 100°.

11. The method of claim 10, wherein the first angle ranges from 25° to 35°.

12. The method of claim 11, wherein the second angle ranges from 85° to 95°.

13. The method of claim 10, wherein the sheet material is formed of a metallic material, the metallic material being spring steel.

14. The method of claim 10, wherein the deforming of the barrel to form the plurality of internal threads further comprises tapping the barrel.

15. The method of claim 10, wherein the sheet material forms a base plate, the longitudinal axis of the barrel extending perpendicular to the base plate.

16. The method of claim 15, wherein the barrel and the base plate are integrally formed as a one piece monolithic structure.

17. The method of claim 10, wherein the internally threaded fastener is one of a u-nut, a t-nut, or a box nut.

18. The method of claim 10, wherein the barrel includes a planar wall extending parallel to the longitudinal axis and between adjacent internal threads of the plurality of internal threads.

19. The method of claim 10, wherein the rearward facing surface includes a first end and a second end, a diverging surface formed at the second end of the rearward facing surface, wherein a third angle between the diverging surface and a second lateral axis perpendicular to the longitudinal axis ranges from 10° to 30°.

20. The method of claim 19, wherein the third angle ranges from 15° to 25°.
